(19) United States
(12) Patent Application Publication
(10) Pub. No.: US 2014/0325556 A1
(43) Pub. Date: Oct. 30, 2014

(54) ALERTS AND WEB CONTENT OVER LINEAR TV BROADCAST

(71) Applicant: MICROSOFT CORPORATION, REDMOND, WA (US)

(72) Inventors: Peter Duyen Hung Hoang, Delta (CA); Daniel Micah Amdur, Seattle, WA (US); William Michael Mozell, North Vancouver (CA); David James Jurenka, Woodinville, WA (US); David Seymour, Vancouver (CA); Henry Stuart Denison Watson, Vancouver (CA)

(73) Assignee: MICROSOFT CORPORATION, REDMOND, WA (US)

(21) Appl. No.: 14/254,673

(22) Filed: Apr. 16, 2014

Related U.S. Application Data
(60) Provisional application No. 61/816,689, filed on Apr. 26, 2013.

(51) Int. Cl. H04N 21/431

(52) U.S. Cl. CPC H04N 21/431
USPC 725/32

(57) ABSTRACT

A system and method are disclosed for enhancing a linear broadcast of a network television program by automatically displaying alerts over the linear broadcast relating to web content determined to be of interest to the linear broadcast or user. The alert may include a link such that, once actioned upon, web content may be presented to the user in addition to the linear broadcast or in the place of the linear broadcast.

### PRIORITY CLAIM

This application claims priority to U.S. Provisional Patent Application No. 61/816,689, filed Apr. 26, 2013, which is incorporated herein by reference in its entirety.

### BACKGROUND

A traditional linear TV broadcast may be considered “dumb” in that it does not contain data streams and has no awareness of other data events happening outside the broadcast. If a TV watcher is interested in getting additional information on what the user is watching or other events, the user may manually access that information from another device. At that point, the information shows up on the other device, not on the TV screen presenting the linear TV broadcast.

### SUMMARY

A system is provided for enhancing a user experience while viewing a linear broadcast. During display of the linear broadcast, an alert notification may be generated and displayed on top of the linear broadcast. The alert overlay includes content relating to the linear broadcast and/or user preferences. The alert notification may be interactive so that a user can select a link in the alert to explore the linked content in greater detail. When a user elects to explore the linked content in greater detail, the alert may expand into a user interface chrome framed around at least a portion of the underlying linear broadcast. The chrome may have links to web content such as an IPTV video which, when selected, is displayed alongside the linear broadcast or in place of the linear broadcast. Upon completion of the user's exploration of the content, the linear broadcast may return full screen to the display.

In one example, the present technology relates to a method for enhancing a user experience with respect to a linear broadcast presented on a display, comprising: (a) receiving an indication from a computing device associated with the display that the linear broadcast is being displayed on the display; (b) identifying web content relating to at least one of the linear broadcast and a user associated with the computing device; and (c) transmitting at least one of the web content identified in said step (b), and an alert notification relating to the web content identified in said step (b), for display in an interactive display area on the display together with the linear broadcast.

In a further example, the present technology relates to a system for enhancing a user experience with respect to a linear broadcast presented on a display, comprising: a set-top box receiving the linear broadcast from a television distribution network; a computing device connected to the set-top box and associated with the display, the computing device receiving the linear broadcast from the set-top box and presenting it on the display, and the computing device receiving web content from a remote server related to at least one of the linear broadcast and user-defined preferences, the computing device including a processor executing an application for at least assisting in the identification of the linear broadcast, the computing device causing the display of the web content instead of or in addition to the linear broadcast in response to received input from a user.

In another example, the present technology relates to a computer-readable media for programming a processor to perform a method of enhancing a user experience with respect to a linear broadcast presented on a display, comprising: (a) identifying the linear broadcast being displayed on the display; (b) receiving web content from a third-party content provider; (c) transmitting for display an alert notification relating to the web content to a computing device associated with the display, the alert notification generated in response to a determination that the web content is related to at least one of the linear broadcast and user preferences; and (d) transmitting the web content to the computing device for display in response to a received interaction with the displayed alert notification.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a network topology for implementing embodiments of the present technology.

FIG. 2 is a system for implementing embodiments of the present technology.

FIG. 3 is a flowchart for initial setup embodiments of the present technology.

FIG. 4 is a flowchart illustrating a first embodiment for generating an alert notification according to the present technology.

FIG. 5 is a flowchart illustrating further detail on the generation and display of an alert notification according to embodiments of the present technology.

FIG. 6 is a flowchart illustrating a second embodiment for generating an alert notification according to the present technology.

FIG. 7 is a flowchart illustrating operation of an embodiment of the present technology upon interaction with an alert notification.

FIGS. 8 to 10 illustrate an embodiment of the present technology to display an alert and user interface chrome providing additional information to a user over a linear broadcast.

FIGS. 11 to 16 illustrate screenshots of a further embodiment of the present technology to display an alert and user interface chrome providing additional information to a user over a linear broadcast.

FIGS. 17 and 18 illustrate a further embodiment including a NUI interface for interacting with an alert and user interface chrome according to the present technology.

FIG. 19 is a block diagram depicting the components of an example entertainment console.

### DETAILED DESCRIPTION

A system is disclosed for enhancing a linear broadcast by automatically displaying alerts over the linear broadcast relating to content determined to be of interest to the linear broadcast and/or user. The content may be related to the linear broadcast, an event in the linear broadcast, or some other event. The alert may be a deep link such that, once actioned upon, a user interface chrome is displayed around the underlying linear broadcast. The chrome may present information enhancing a user's viewing experience of the underlying linear broadcast, or may allow the user to discover other content potentially of greater interest to the user than the linear broadcast by itself.

The user interface chrome may also present a link to web content such as an IPTV video. If actioned upon, a companion window opens on the display presenting the selected content. The companion window may display split screen alongside the linear broadcast, or may be displayed full screen replacing the linear broadcast. Upon completion or termination by the user, the companion window may close and the underlying linear broadcast may return within the user interface chrome or full screen to the display.

Embodiments of the technology described below are presented in the context of sports-related linear broadcasts enhanced with alerts for accessing additional sports-related web content. However, it is understood that the present technology may be used to present a television experience with linear broadcasts and/or web content that are unrelated to sports. Such television experiences may relate in whole or in part to news and current events, entertainment, shopping, music videos, and other subject matter.

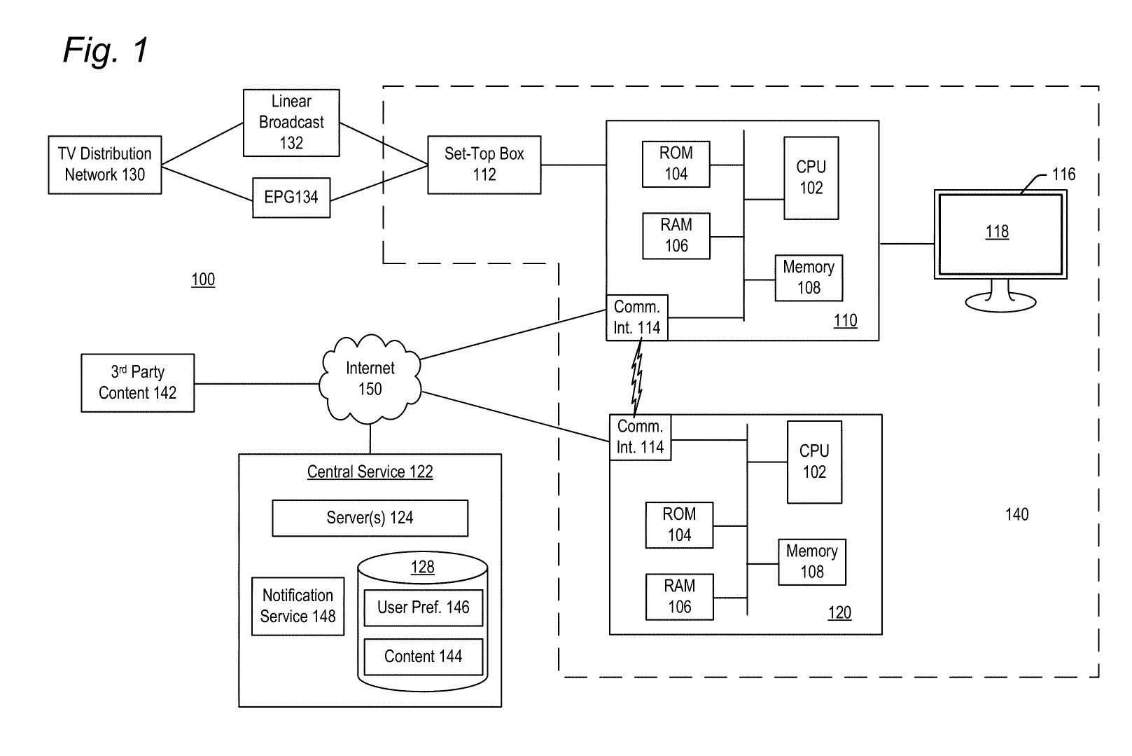

Referring to FIG. 1, there is shown a schematic block diagram of a network topology 100 for implementing embodiments of the present technology. Network topology 100 includes infrastructure for presenting traditional linear television broadcasts. In particular, linear broadcasts are provided by a television distribution network 130, which may be for example a terrestrial television network (ABC, CBS, NBC, etc.), a cable TV provider, a satellite TV provider or other television distribution network. The network 130 distributes a video feed including a linear broadcast 132 and an electronic program guide (EPG) 134. The linear broadcast feed may be any traditional broadcast television content. The EPG includes a breakdown of programming information by channel as to what linear broadcast content is presented and the times of such broadcasts. The EPG data may be customized by geographic location, and further typically includes metadata related to the linear broadcast, including for example a title of the linear broadcasts, the type of video broadcast (sports, entertainment, news, etc.), who is to appear in the linear broadcasts, and a numeric identifier for each linear broadcast.

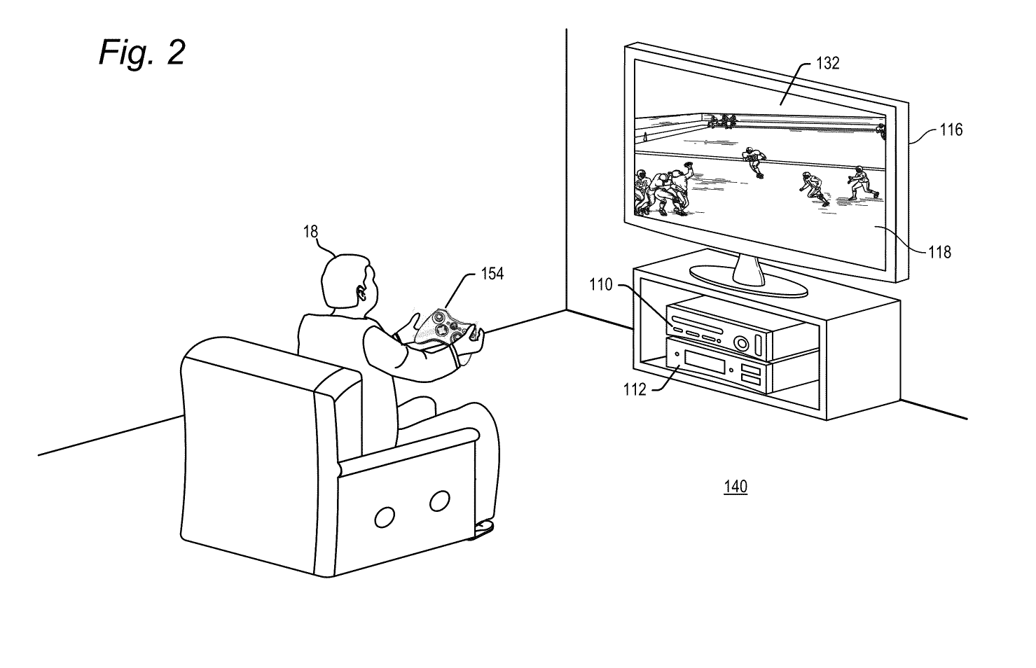

The linear broadcast 132 and EPG 134 may be received within a set-top box 112 for presentation on a display 118 of a television or other A/V device 116. The set-top box 112 and A/V device 116 may be collocated within a location 140 such as for example a home, office, etc. (indicated by the dashed line in FIG. 1). A computing device 110 (also referred to herein as client computing device) is further at location 140, connected between the set-top box 112 and the A/V device 116. FIG. 2 illustrates a location 140 with a user 18 watching a linear broadcast 132 on an A/V device 116 provided by the set-top box 112 and computing device 110.

Traditionally, the set-top box 112 and computing device 110 both had parallel connections to the A/V device 116. However, to aid in implementing aspects of the present technology, the linear broadcast 132 and EPG from the set-top box 112 are transmitted through the computing device 110 to the A/V device 116. In embodiments, HDMI connections may be used between the set-top box 112 the computing device 110 so that the linear broadcast 132 may be rendered as an HDMI pass-through video by the computing device 110 on the A/V device 116.

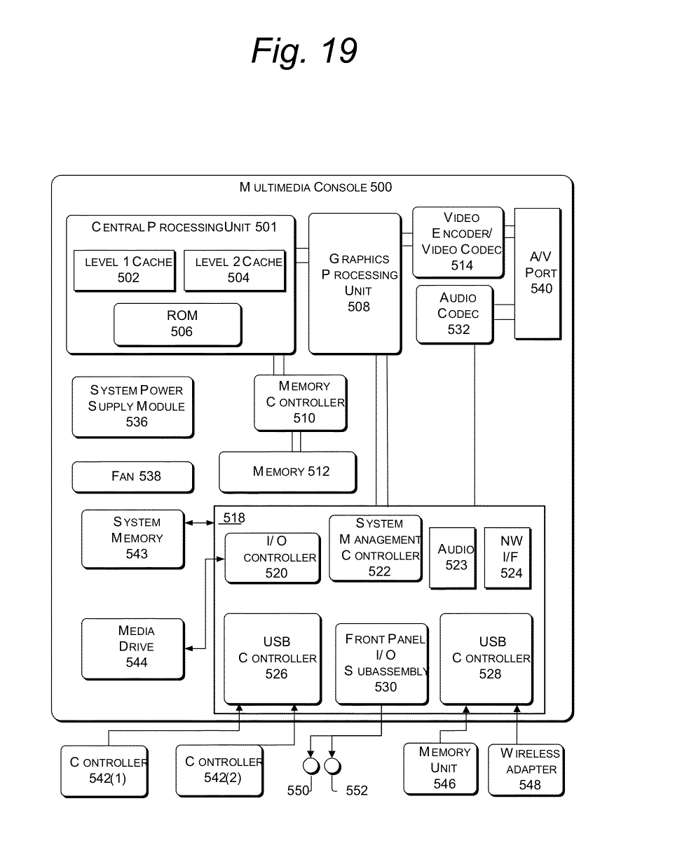

Details of an implementation of computing device 110 are provided below with respect to FIG. 19. However, in general, computing device 110 may be a desktop computer, media center PC, a gaming console and the like. As one example allowing HDMI pass-through, computing device 110 may be the Xbox One® video game console from Microsoft Corp, Redmond, Calif. Computing device 110 may alternatively be a portable computer such as a laptop, tablet or other device in further embodiments. Computing device 110 may include a processor such as CPU 102 having access to read only memory (ROM) 104 and random access memory (RAM) 106. Device 110 may further include a non-volatile memory 108 for storing data and application programs, such as an alert notification application for implementing aspects of the present technology as explained below.

The computing device 110 may be connected to the A/V device 116, which may for example be a monitor, a high-definition television (HDTV), or the like that may provide a video feed, game or application visuals and/or audio to a user 18 (FIG. 2). For example, the computing device 110 may include a video adapter such as a graphics card and/or an audio adapter such as a sound card that may provide audio/visual signals associated with recorded or downloaded linear broadcasts and web content. In one embodiment, the audio/visual device 116 may be connected to the computing device 110 via, for example, an S-Video cable, a coaxial cable, an HDMI cable, a DVI cable, a VGA cable, a component video cable, or the like. In further embodiments, the display 118 may not be a separate A/V device 116, but may instead be incorporated as part of computing device 110.

As explained below, the linear broadcast experience may be enhanced with web content received from a central service 122 and/or a third-party content provider 142. The central service 122 may include one or more servers 124 for aggregating content feeds from one or more third-party content providers 142. Aggregated content 144 may be stored in a central storage location 128 within or associated with the central service 122. As explained below, the central service 122 may not store content 144, with it instead coming directly from the one or more third-party content providers 142. In embodiments, one or more of the third-party content providers 142 may be owned, associated with or partnered with the central service 122. In further embodiments, the third-party content provider(s) 142 may be independent of the central service 122.

The central storage 128 of service 122 may further include a user records store 146. Such records include stored profiles and user preferences for one or more users. In the context of one embodiment of the present technology, user records may store sports preference information for a user, such as for example their favorite teams and players, their sports fantasy teams for fantasy sports leagues they participate in, sporting events they would like to watch and sports content they would like to receive, etc. This information may additionally or alternatively include a wide variety of other non-sports related information. A user may store this information with the central service 122 over time. It is further contemplated that the user records store 146 may be stored locally on computing device 110 instead of or in addition to the store 146 on the central service 122. The central service 122 may further include a notification service 148 for providing alert notifications to users as explained below.

In embodiments, the central service 122 and third-party content provider(s) 142 may be network connected to the remote computing device 110 via a network connection such as the Internet 150 and a communications interface 114 within the computing device 110.

In embodiments, a second computing device 120 may optionally be provided at location 140. As explained below, the second computing device 120 may be provided for interacting with a displayed user interface chrome providing access to web content over the display 118 to enhance the user's television experience. Alternatively, as explained below, the computing device 120 may provide a second display so that web content may be displayed on the second computing device while the linear broadcast is displayed on A/V device 116. The computing device 120 may be a portable computer such as a laptop, tablet, smartphone or remote control, though it may be a desktop computer in further embodiments. Details of an implementation of computing device 120 are described below with respect to FIG. 19. However, in general, computing device 120 may include a processor such as CPU 102 having access ROM 104, RAM 106 and a non-volatile memory 108 for storing data and application programs.

In embodiments including two computing devices such as computing devices 110 and 120, the system may be practiced in a distributed computing environment. In such embodiments, devices 110 and 120 may be linked through a communications network implemented for example by communications interfaces 114 in the computing devices 110 and 120. One such distributed computing environment may be accomplished using the Smartglass™ software application from Microsoft Corporation which allows a first computing device to act as a display, controller and/or other peripheral to a second computing device.

It is understood that other user interface schemes may be used to interact with the computing device 110. FIG. 2 illustrates a user 18 having a game controller 154 for interacting with an alert or user interface chrome as explained below. In a further embodiment explained below, the computing device 110 may implement a natural user interface (NUI) system allowing a user to interact with the computing device 110 through gestures and speech.

It is understood that the functions of computing devices 110 and/or 120 may be performed by numerous other general purpose or special purpose computing system environments or configurations. Examples of other well-known computing systems, environments, and/or configurations that may be suitable for use with the system include, but are not limited to, multiprocessor systems, microprocessor-based systems, set-top boxes, programmable consumer electronics, network PCs, minicomputers, distributed computing environments that include any of the above systems or devices, and the like.

A system is provided for displaying a linear broadcast video and an alert notification displayed on top of the video. The alert includes data relating to the video. The alert may be interactive so that a user can select a link in the alert to explore the linked data in greater detail. When a user elects to explore the linked data in greater detail, the alert may increase in size and/or change to a larger user interface, and the underlying video may decrease in size. Upon completion of the user's exploration of the linked data, the underlying video may return to their original relative sizes.

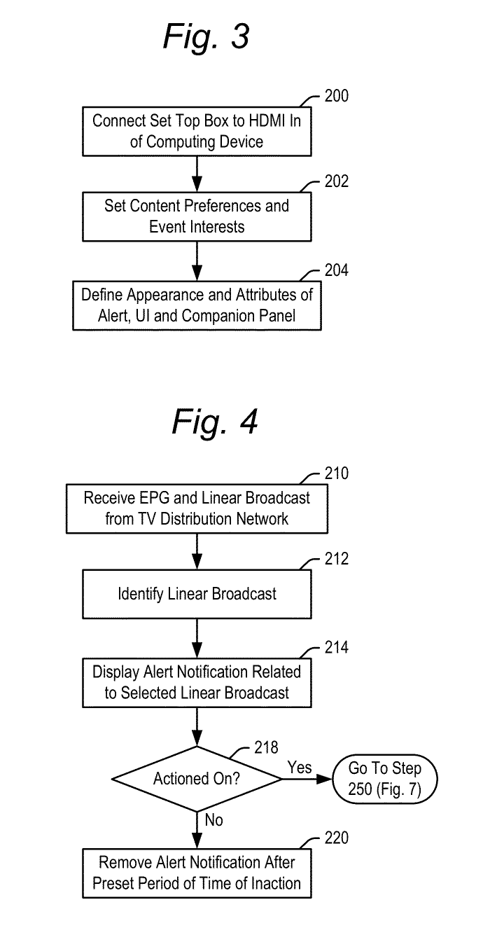

A flow for setting up the system of the present technology will now be explained with reference to the flowchart of FIG. 3. In step 200, the set-top box 112 may be serially connected to the HDMI IN port of the computing device 110 to provide video pass-through via computing device 110 as explained above. In step 202, content preferences and event interests may be set. In embodiments, this information may be stored in user record store 146 of the central service 122 as explained above. The step 202 may be performed in contemplation of receiving alert notifications according to the present technology. However, as noted above, user preferences and event interests may be built up and stored by user with the service 122 over time, including prior to step 200. This information may also be modified or supplemented after system set up, for example during use of the system as explained below.

As is further explained below, it is contemplated that the present technology may operate without user record store 146 or stored user preferences. In such an embodiment, alert notifications may be generated and sent to the user based on a determined contextual relevance of the alert content to the linear broadcast 132 or a specific event or specific portion of the linear broadcast 132, without reference to user preferences.

The setup routine of FIG. 3 may further include a step 204 setting the appearance and attributes of the alert notification, the user interface chrome and/or the companion panel, each of which is explained below. In particular, a user may be provided with the option to setup how and when alert notifications are to be displayed over a linear broadcast, including where on the display 118 the alert is to appear. A user may also be allowed to configure the appearance of the user interface chrome, such as for example whether it wraps around a portion of the display 118 or the entire display 118. A user may further be provided with the option to configure a companion panel, for example as to its size and position relative to the display of the linear broadcast. In further embodiments, step 204 may be omitted and each of these attributes may be set with default parameters.

Upon completion of setup, the present system may be used for example as will now be described with reference to the flowchart of FIG. 4. In step 210, the computing device 110 may receive the EPG data and linear broadcast from the TV distribution network 130, via the set-top box 112. The linear broadcast 132 may be displayed on the A/V device 116, such as for example as shown in FIG. 2. As noted, the linear broadcast 132 may relate to any subject matter. It may be a video feed having no awareness of other data events happening outside the broadcast.

In step 212, an alert notification application running on computing device 110 may identify the linear broadcast being displayed on the A/V device 116. This may be done a variety of ways, but in one example, the alert notification application may determine the linear broadcast from examining the data from the EPG, including for example a program identifier, the date, time and channel a user is watching. The alert notification application may alternatively or additionally identify the linear broadcast from data received from the central service 122 or other third-party website. In embodiments, the computing device 110 and a server 124 in the central service 122 may work together to identify the linear broadcast, or one or the other of computing device 110 and the server 124 may identify the linear broadcast by itself.

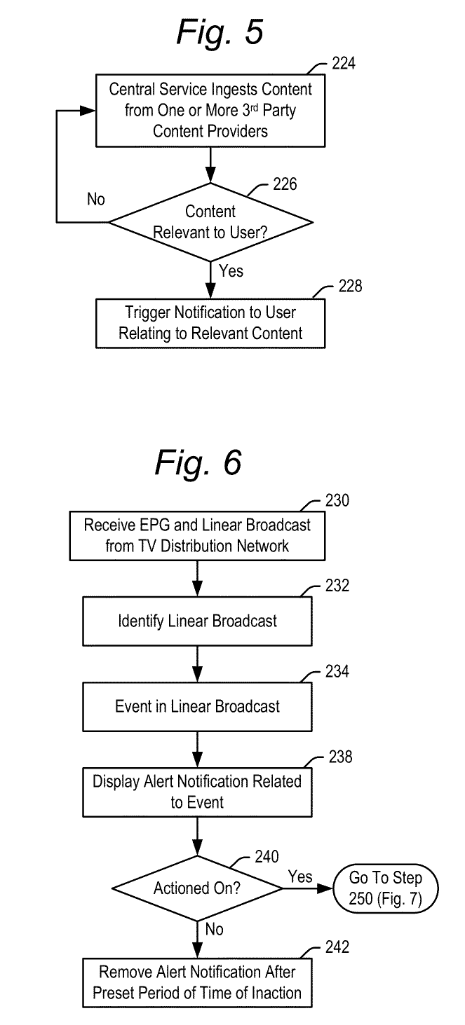

Once the linear broadcast identified in step 212, the alert notification application may periodically display alert notifications related to the linear broadcast or other topic in step 214. In the embodiment of FIG. 4, alert notifications are triggered based off the linear broadcast as a whole. As explained below, in further embodiments, alert notifications may be triggered based on specific portions of the linear broadcast or specific events that occur during a linear broadcast. Further details of step 214 of FIG. 4 will now be explained with reference to the flowchart of FIG. 5.

In step 224, the central service 122 ingests and stores content from one or more third party content providers 142 via the network 150. The step 224 may be periodically or continuously performed, and may occur in parallel with the steps described above and below for FIG. 4. In step 226, the central service 122 determines whether received content is relevant to a particular user. In particular, the service 122 may compare metadata describing received content against user preferences stored in user record store 146.

If the service 122 identifies relevant information, the service 122 may further determine whether that information is contextually relevant to the user. For example, with respect to the embodiment of FIG. 4, the service 122 may determine whether information is contextually relevant to the linear broadcast the user is watching. As explained below, contextual relevance may instead relate to particular events that occur in a linear broadcast. As is further explained below, contextual relevance may not be related to the linear broadcast in determining whether to send an alert notification. In such embodiments, a user may receive alert notifications relating to content that is potentially of interest to the user, even where the content has no relation to the linear broadcast then being watched by the user.

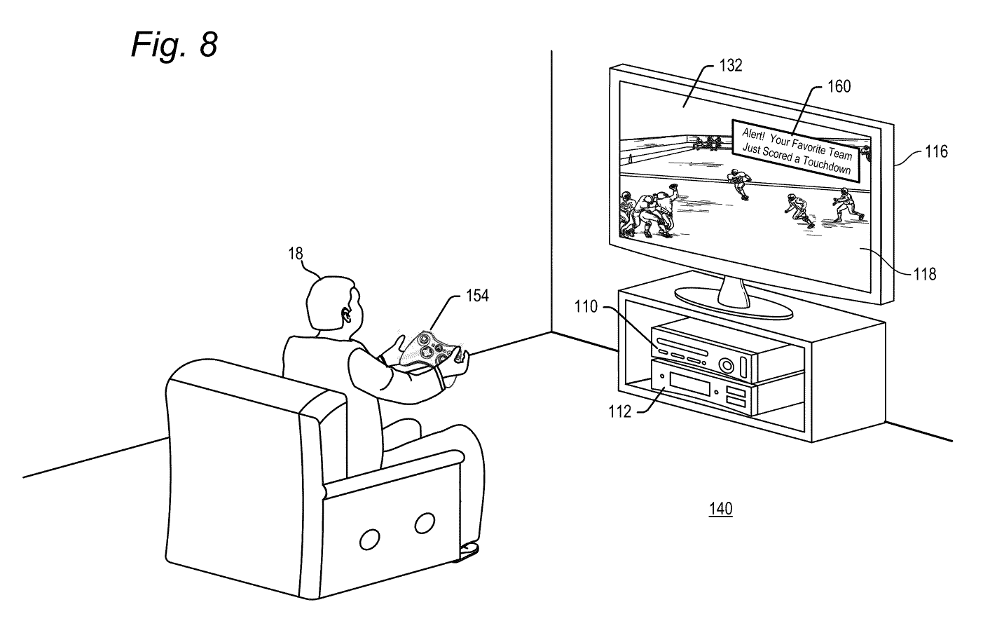

If content is determined to be relevant to a user in step 226, the notification service 148 of the central service 122 generates an alert which is sent to the user via network 150. This alert is displayed to the user in step 214 of FIG. 4. One example of an alert notification 160 is shown in FIG. 8. The alert notification 160 is displayed over (on top of) the linear broadcast 132, and includes text and/or graphics generated by the notification service 148 briefly describing the relevant content identified by the central service 122 as being potentially of interest to the user.

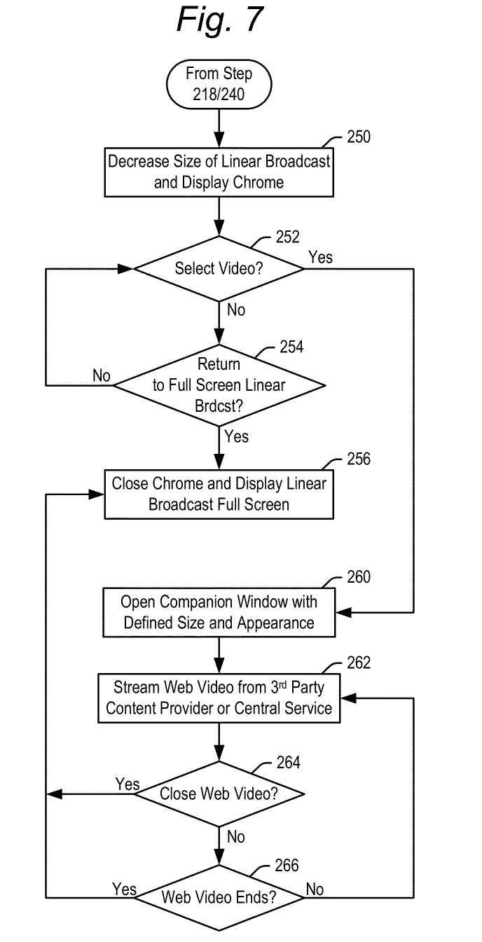

Referring again to the flowchart of FIG. 4, an alert notification 160 may include a deep link such that it may be selected, or actioned on, by a user to trigger presentation of additional information to the user relating to the subject matter of the alert notification 160. If an alert notification 160 is actioned on in step 218, a user interface chrome is presented to the user in step 250 as explained below with respect FIG. 7. On the other hand, a user may ignore an alert notification 160. In step 220, the alert notification may be removed from the display 118 after a preset period of time without interaction with the alert. At that time, the user's linear broadcast may return full-screen until such time as a further alert notification 160 is generated and displayed.

As noted above, alerts 160 may be generated in a wide variety of contextual situations. In the example of FIG. 4, the subject matter of a selected linear broadcast 132 may trigger an alert relating to content that is relevant to the user and the selected linear broadcast. FIG. 6 illustrates a further example where specific events depicted in a linear broadcast 132 may trigger alerts 160. In step 230, computing device 110 receives the EPG and linear broadcast from the TV distribution network via the set-top box as described above. In step 232, the alert notification application running on computing device 110 may identify the linear broadcast as described above.

In step 234, an event occurs in the linear broadcast. For example, as noted above, the linear broadcast may relate to a sports competition. Some event may take place in the competition that is captured in video and depicted in the linear broadcast. This event may be a highlight of the sports competition but generic to the user, such as for example a touchdown or long run in football, a home run or double play in baseball, etc. Or the event may be specifically relevant to the user, such as for example a play involving the user's favorite football player or player on his/her fantasy football team, etc. As explained above with respect FIG. 5, third-party content providers may also be monitoring the sports competition, and may generate content related to one or more events that occur in the competition. This content may be ingested and stored by the central service 122.

Thus, in the above example, the alert notification application on computing device 110 may determine that a user is watching a linear broadcast, which information is transmitted to the central service 122. When the central service 122 determines that it has content on some event that is depicted in or related to the linear broadcast which is potentially of interest to the user, the notification service 148 may generate and send an alert notification 160 to the user relating to that event. The alert notification 160 may be displayed on the A/V device 116 in step 238. Thereafter, the alert notification 160 may be actioned on in step 240 at which point, additional information on the event is displayed to the user as explained below. If the alert notification 160 is not actioned on after a preset period of time, the alert may disappear as described above.

In the examples described above with respect to the flowcharts of FIGS. 4 and 6, alerts 160 are generated which are contextually related to the linear broadcast 132 that passes through the computing device 110 and is displayed on A/V device 116. In a further embodiment, alerts 160 may be generated when the alerts have no contextual relevance to the underlying linear broadcast 132. In such embodiments, where the central service 122 determines that it has stored content that may be of interest to a user, based on the user's stored profile of interests, the notification service 148 may generate and send an alert to be displayed on the A/V device 116 regardless of what linear broadcast is also being displayed.

As one of many examples, the user may be watching a movie, when an alert notification 160 is generated and displayed letting the user know that the user's favorite team is about to start playing a game. As a further example, a user may be watching a movie or a sporting event, when an alert notification 160 is generated and displayed letting the user know that the user's favorite player has just scored a touchdown in a game not being shown in the underlying linear broadcast. In these examples, the alerts may be said to have a temporal contextual relevance (in that they relate to an event that has just occurred or is about to occur) instead of any relevance to the underlying linear broadcast.

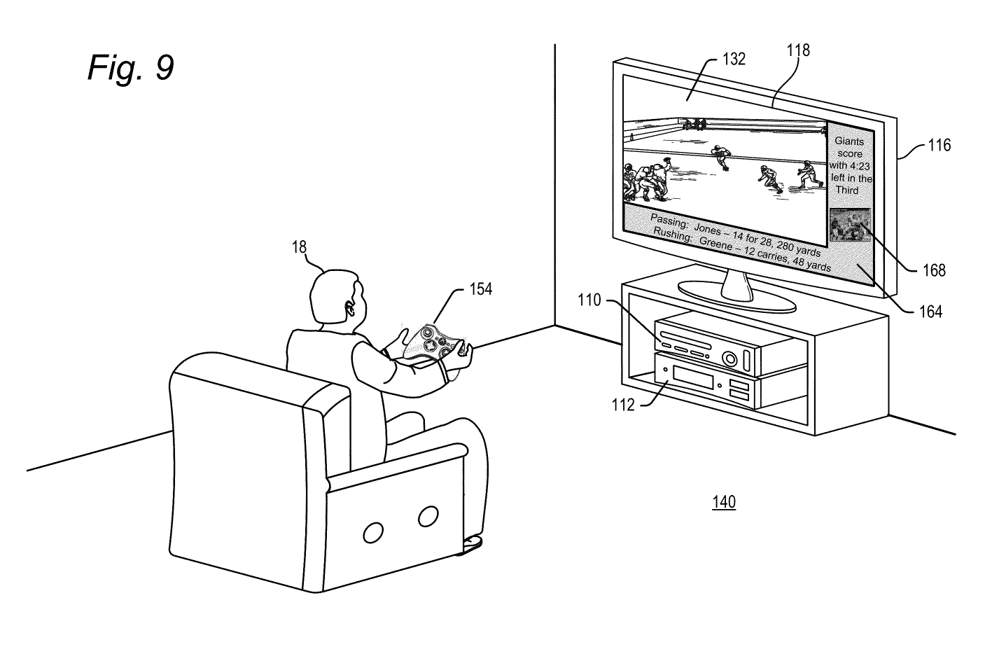

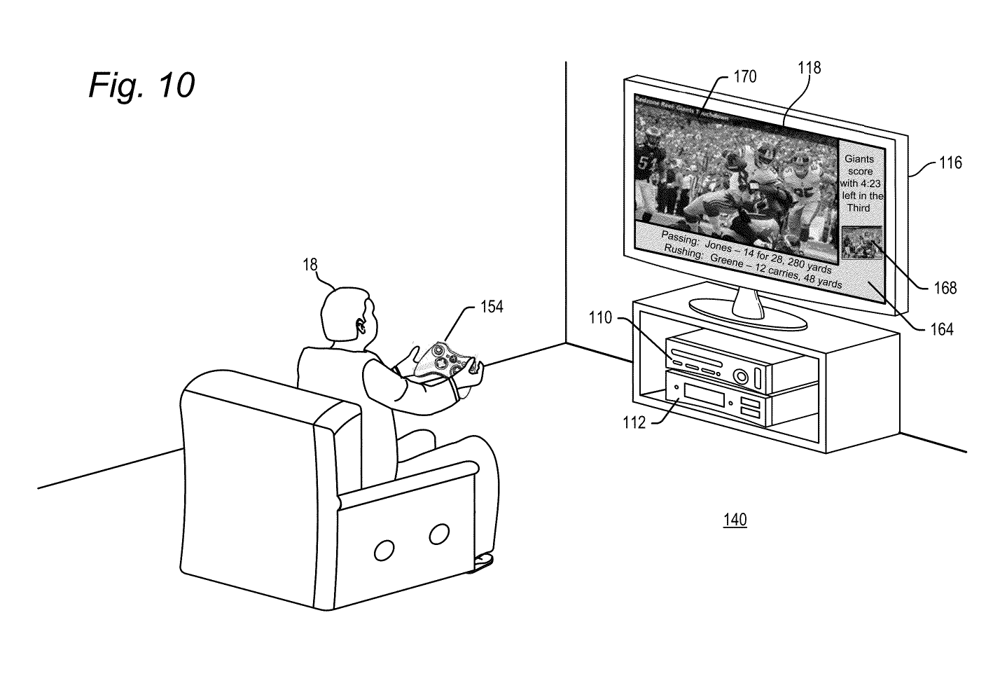

Referring now to FIG. 7, if a user actions on an alert notification 160 in step 218 (FIG. 4) or step 240 (FIG. 6), a user interface chrome may be displayed to a user in step 250. An example of a user interface chrome 164 is shown for example in FIGS. 9 and 10. The size of the linear broadcast 132 may also be decreased in step 250 to accommodate the chrome 164 while still showing all of the linear broadcast 132. In the example of FIGS. 9 and 10, the chrome 164 is an L-shaped chrome extending down one side and across the bottom of the display 118. It is understood that the chrome 164 may frame the linear broadcast 132 along any of one, two, three or all four edges of the linear broadcast 132. As noted above, the location of the chrome 164 may be user-configurable or set by default by the alert notification application.

The user interface chrome 164 may include a wide variety of text, graphics and images providing additional information related to the alert notification 160 that was actioned on. For example, for alerts related to a sporting competition, the chrome 164 may display a game summary, a description of one or more events from the competition, related news stories, and/or historical, statistical and biographical information. This information may come from the central service 122, which may generate and store the information on its own, or receive the information from one or more third-party content providers such as content provider 142.

The chrome 164 may further include embedded links to additional information located on remote servers (within central service 122 or other third-party content provider 142). Referring to FIGS. 7 and 9, the user interface chrome 164 may for example include a video link 168 which, when actioned upon in step 252, displays an IPTV web video associated with the video link 168 on the A/V device 116. Video link 168 may for example be an image of a video frame from the video associated with the link 168.

In step 252, a user has the option of selecting a link, such as video link 168, or closing the chrome in step 254. If the user elects to close the chrome, then the linear broadcast 132 may return full screen to the display 118 in step 256.

On the other hand, if a user selects a link such as video link 168, a companion window may open (step 260) in which the video is displayed (step 262). The video may be streamed from a third-party content provider such as provider 142, or directly from the central service 122. An example of a companion window 170 displaying a video associated with the video link 168 is shown in FIG. 10.

The size of the companion window may vary, as defined by the user in the user records store 146 of service 122, or it may have default settings determined by the alert notification application. In the example of FIG. 10, the companion window 170 completely replaces the linear broadcast. However, in further embodiments, the companion window 170 may be displayed alongside the linear broadcast, and be of variable size relative to the underlying broadcast. The companion window may display within the chrome 164, or it may replace the chrome 164.

Referring again to FIG. 7, the alert notification application may look for interaction with the chrome 164 closing the web video in step 264. A link may be provided on the chrome 164 for this purpose. If no such interaction is detected, the alert notification application may look for an end to the web video in step 266. If the web video is terminated or ends in either of steps 264 or 266, the chrome 164 may be closed in step 256, and the linear broadcast 132 may be returned full screen to the A/V device 116 at its current time location in the video. In further embodiments, the linear broadcast may be buffered when an IPTV video is displayed full screen so that it may return to the point at which the linear broadcast was replaced by the web video.

In further embodiments, once a web video ends or is terminated, instead of closing the chrome 164, the companion window may close, but the chrome may remain displayed. Thereafter, a user may select another video link 168 in step 252 or close the chrome in step 254.

In the above example, the chrome 164 included a link 168 to a video. However, it is understood that links to a variety of different web content may be provided in text and/or graphics on the chrome 164. For example, a player's name may be displayed as an actionable link, which, when selected, displays text, images and/or video about the player in a companion window 170 as described above. As noted, the text, images and/or video may come from central service 122 or directly from a third party content provider 142. In a further example described below, selection of a link in either the alert notification 160 or chrome 164 may bring up additional information that is displayed on the second client device 120 (FIG. 1), instead of the A/V device 116 that is displaying the underlying linear broadcast 132.

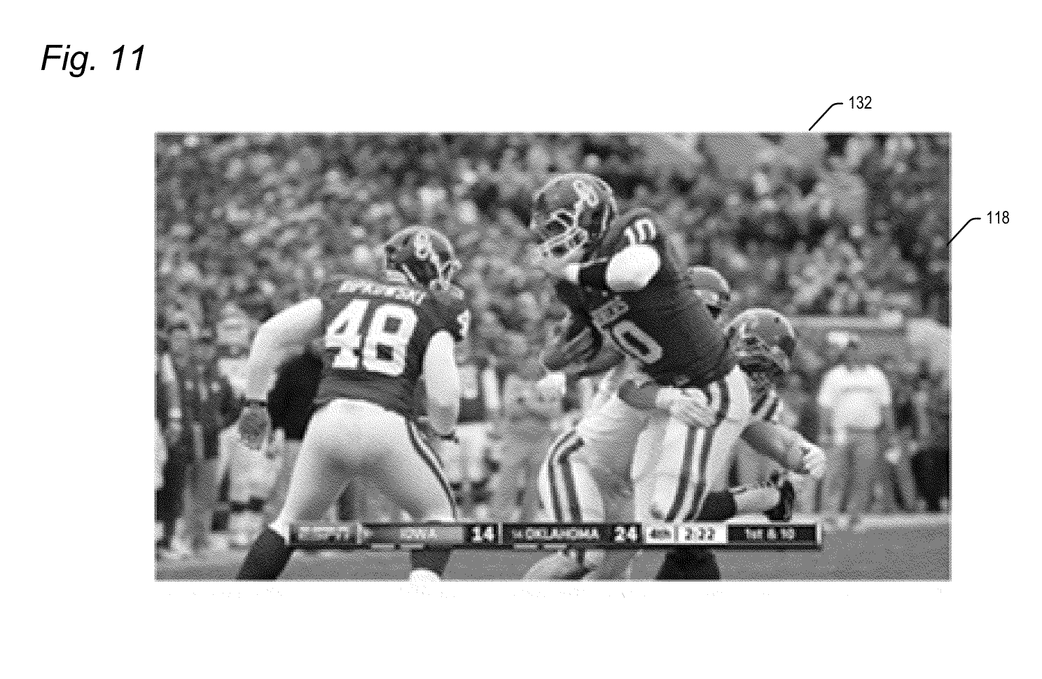

FIGS. 11-16 illustrate a further example of the present technology. FIG. 11 illustrates a linear broadcast 132, passed through the computing device 110 for display on the A/V device 116. In embodiments, the video may be identified, and thereafter a search may be performed to identify information relating to the video. This identification and search may be performed by the user's computing device 110 or central service 122 linked to the client's computing device by the network 150 such as for example the Internet.

In embodiments, the video may for example be identified using electronic program guide (EPG) data and metadata relating to the scheduled TV program video that the user is viewing. Alternatively, the central service 122 may keep track of the content being displayed. In such an embodiment, the central service 122 is able to identify and provide information relating to the video.

In embodiments described above, content from one or more third party content providers 142 may be stored in advance of the linear broadcast 132 being displayed. In further embodiments, once the linear broadcast is identified, the client computing device 110 or central service 122 may use the TV program ID from the EPG to query for data or data feeds relevant to the identified linear broadcast. This query may be performed in servers 124 of the central service 122 or over the World Wide Web in general such as for example in the one or more third party content providers 142. The program ID and/or keywords from the metadata associated with the program in the EPG or from the central service 122 may be used as keyword searches to identify relevant data, events and/or data feeds.

Once data, events and/or one or more data feeds (collectively referred to herein as cloud data) relevant to the linear broadcast video are identified, the client computing device 110 or central service 122 may associate the cloud data with the linear broadcast video 132. As noted above, it is contemplated that cloud data may relate to the linear broadcast video in general, or to specific events or specific portions of the linear broadcast video.

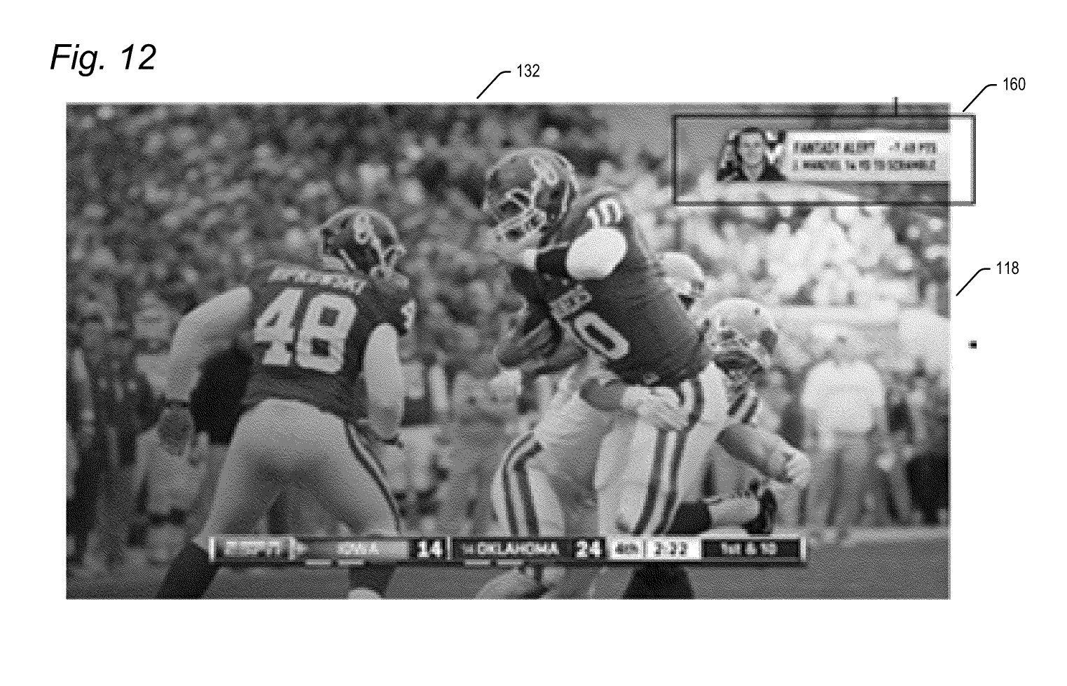

The cloud data may be monitored by the client computing device 110 or central service 122 while the linear broadcast is playing. Cloud data that is identified as being relevant to the user may trigger an alert notification 160 that is displayed on top of the linear broadcast, as shown in FIG. 12. Cloud data may be identified as being relevant to the user in a number of ways. In one example, the cloud data may be user-independent, but has been identified as being relevant to the linear broadcast or a portion of the linear broadcast. In a further example, the client computing device 110 or central service 122 may be aware of stored user preferences and may use those preferences to identify cloud data which is relevant to the linear broadcast and/or a particular user.

As shown in FIG. 12, the alert notification 160 may be a relatively small display window in comparison to the linear broadcast 132 so as not to obscure a user's view of the broadcast 132. In the example of FIG. 12, the alert notification 160 may relate to fantasy points in a fantasy football league that has been earned by a particular player (for example the player then being displayed on the linear broadcast video) up to that point in time. It is understood that the information displayed in an alert notification 160 may be any of a wide variety of cloud data available to the central service 122 or the World Wide Web in general. Of note, the alert notification 160 may provide information which is not included in the linear broadcast itself.

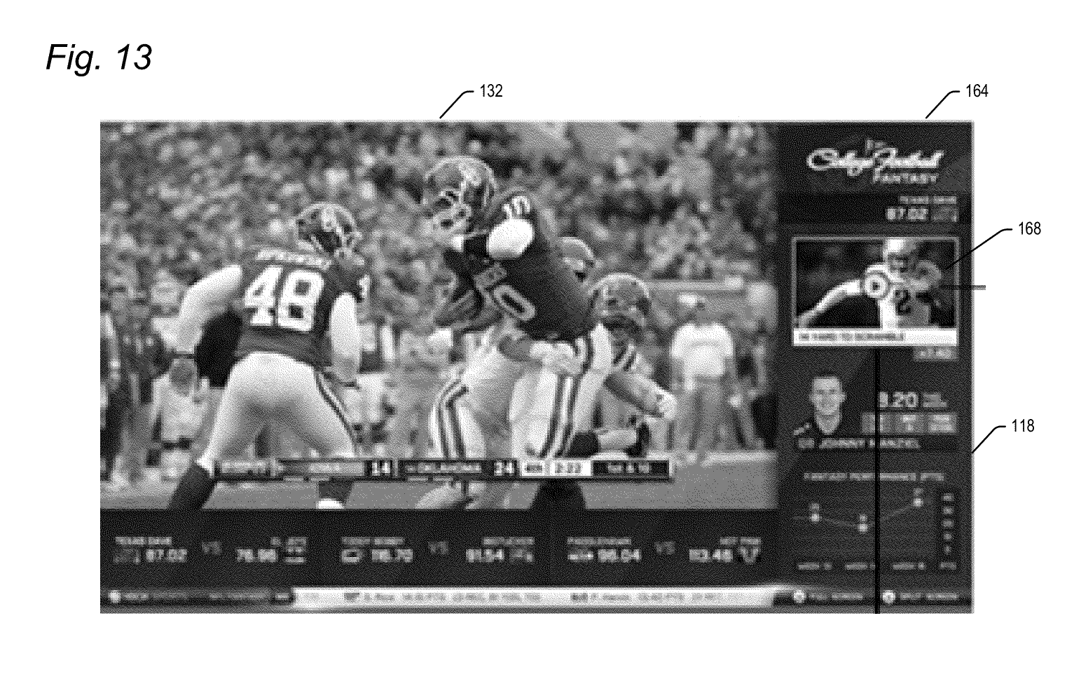

As described above, the alert notification 160 may include a link so as to be interactive. Upon a user selecting the alert notification 160, such as for example via a selection device or other interface, the alert notification 160 may be expanded into the user interface chrome 164 and provide additional information, as shown in FIG. 13. This additional information may relate to a specific event or the linear broadcast in general, and may be any of a variety of information including news stories, or historical, statistical and biographical information.

The expanded user interface chrome 164 shown in FIG. 13 may include additional links providing additional information about something which is displayed in the chrome 164. In one example, the central service or other cloud services may use the cloud data to query for relevant related IPTV video content. If found, a video link 168 may also be displayed as part of the chrome 164 as shown in FIG. 13. A user may select the link 168 to view the supplemental web video content in a companion window 170 in greater detail.

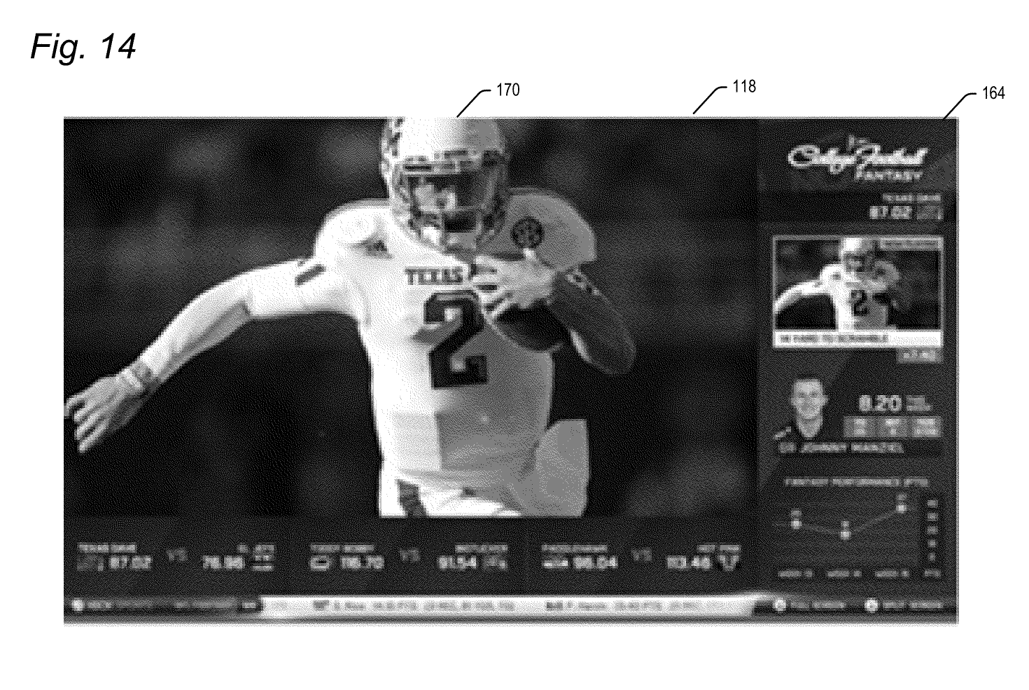

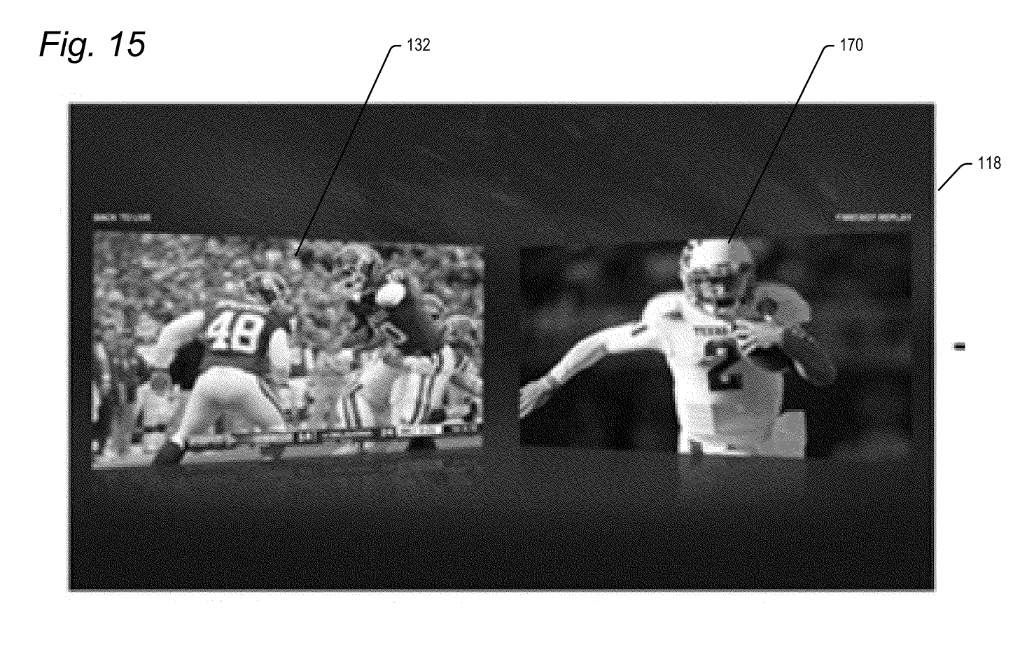

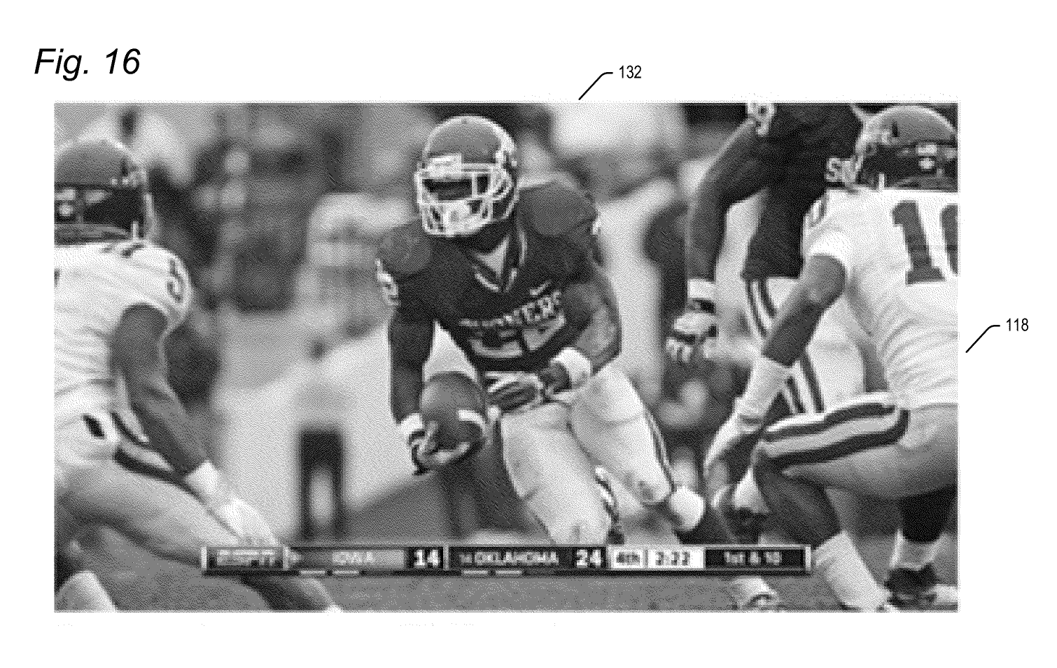

In one embodiment, where a user selects a link in the chrome 164, such as for example the link 168 for supplemental web video content, that content may be played back over the linear broadcast video 132 at full-screen, such as for example as shown in FIG. 14. Upon completion or termination of the web content displayed in companion window 170, the display may automatically transition back to the underlying linear broadcast 132 (FIG. 15) until the underlying linear broadcast 132 is again playing at full-screen (FIG. 16).

In an alternative embodiment, selection of a link in either the alert notification 160 or expanded chrome 164 may bring up additional information that is displayed on the second client device 120 (FIG. 1), instead of the A/V device 116 that is displaying the underlying linear broadcast video 132. As discussed above, the Smartglass™ software application from Microsoft Corporation is a known software platform allowing information to be viewed on a second connected device in this manner.

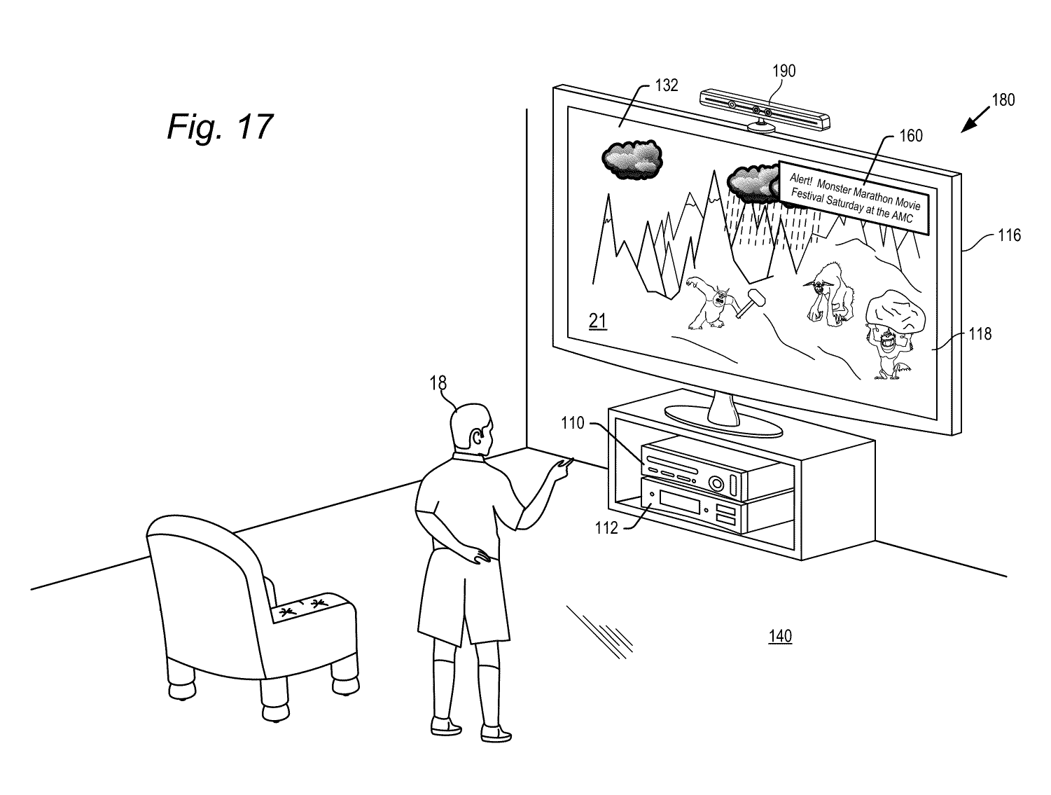

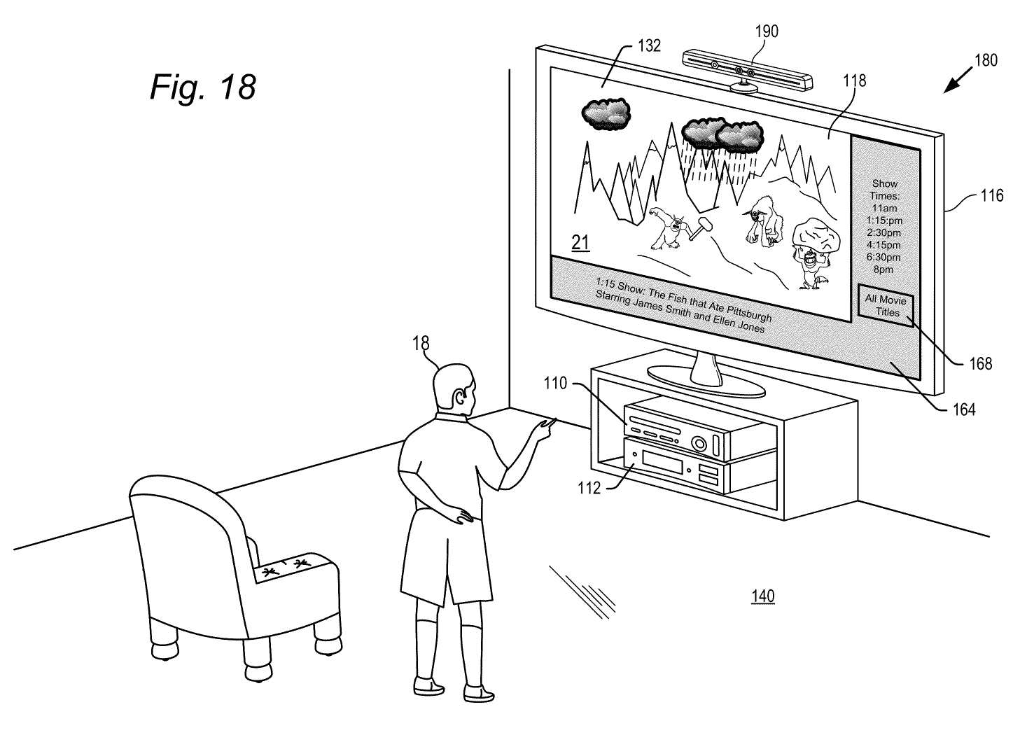

FIGS. 17 and 18 illustrate a further example of a NUI system 180 that can provide a natural user interface for interacting with alerts 160 and the chrome 164. NUI system 180 may include the computing device 110 and A/V device 116 as described above. The NUI system 180 may further include a capture device 190, which may be, for example, a camera. Using the capture device 190, the NUI system 180 may be used to recognize, analyze, and/or track one or more humans. For example, a user 18 may be tracked using the capture device 190 such that the gestures and/or movements of user may be captured and interpreted as interactions with the alert notification 160 or the user interface chrome 164.

FIGS. 17 and 18 also illustrate the present technology in a non-sports related context. In this example, a user is watching a linear broadcast 132 of a monster movie, but as noted, it could any of a wide variety of contents. The present system identifies the linear broadcast, and then provides an alert which may be relevant to the broadcast, the user or both. When the user actions on the alert notification 160 in FIG. 17, the user interface chrome 164 is presented as shown in FIG. 18 with additional information. The non-sports related example of FIGS. 17 and 18 may employ user interfaces other than a NUI system.

FIG. 19 illustrates an example embodiment of a computing system that may be used to implement computing devices 110, 120. As shown in FIG. 19, the multimedia console 500 has a central processing unit (CPU) 501 having a level 1 cache 502, a level 2 cache 504, and a flash ROM 506 that is non-volatile storage. The level 1 cache 502 and a level 2 cache 504 temporarily store data and hence reduce the number of memory access cycles, thereby improving processing speed and throughput. CPU 501 may be provided having more than one core, and thus, additional level 1 and level 2 caches 502 and 504. The flash ROM 506 may store executable code that is loaded during an initial phase of a boot process when the multimedia console 500 is powered on.

A graphics processing unit (GPU) 508 and a video encoder/video codec (coder/decoder) 514 form a video processing pipeline for high speed and high resolution graphics processing. Data is carried from the graphics processing unit 508 to the video encoder/video codec 514 via a bus. The video processing pipeline outputs data to an A/V (audio/video) port 540 for transmission to a television or other display. A memory controller 510 is connected to the GPU 508 to facilitate processor access to various types of memory 512, such as, but not limited to, a RAM.

The multimedia console 500 includes an I/O controller 520, a system management controller 522, an audio processing unit 523, a network (or communication) interface 524, a first USB host controller 526, a second USB controller 528 and a front panel I/O subassembly 530 that are preferably implemented on a module 518. The USB controllers 526 and 528 serve as hosts for peripheral controllers 542(1)-542(2), a wireless adapter 548 (another example of a communication interface), and an external memory device 546 (e.g., flash memory, external CD/DVD ROM drive, removable media, etc. any of which may be non-volatile storage). The network interface 524 and/or wireless adapter 548 provide access to a network (e.g., the Internet, home network, etc.) and may be any of a wide variety of various wired or wireless adapter components including an Ethernet card, a modem, a Bluetooth module, a cable modem, and the like.

System memory 543 is provided to store application data that is loaded during the boot process. A media drive 544 is provided and may comprise a DVD/CD drive, Blu-Ray drive, hard disk drive, or other removable media drive, etc. (any of which may be non-volatile storage). The media drive 544 may be internal or external to the multimedia console 500. Application data may be accessed via the media drive 544 for execution, playback, etc. by the multimedia console 500. The media drive 544 is connected to the I/O controller 520 via a bus, such as a Serial ATA bus or other high speed connection (e.g., IEEE 1394).

The media console 500 may include a variety of computer readable media. Computer readable media can be any available tangible media that can be accessed by computer 441 and includes both volatile and nonvolatile media, removable and non-removable media. Computer readable media does not include transitory, transmitted or other modulated data signals that are not contained in a tangible media.

The system management controller 522 provides a variety of service functions related to assuring availability of the multimedia console 500. The audio processing unit 523 and an audio codec 532 form a corresponding audio processing pipeline with high fidelity and stereo processing. Audio data is carried between the audio processing unit 523 and the audio codec 532 via a communication link. The audio processing pipeline outputs data to the A/V port 540 for reproduction by an external audio user or device having audio capabilities.

The front panel I/O subassembly 530 supports the functionality of the power button 550 and the eject button 552, as well as any LEDs (light emitting diodes) or other indicators exposed on the outer surface of the multimedia console 500. A system power supply module 536 provides power to the components of the multimedia console 500. A fan 538 cools the circuitry within the multimedia console 500.

The CPU 501, GPU 508, memory controller 510, and various other components within the multimedia console 500 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 500 is powered on, application data may be loaded from the system memory 543 into memory 512 and/or caches 502, 504 and executed on the CPU 501. The application may present a graphical user interface that provides a consistent user experience when navigating to different media types available on the multimedia console 500. In operation, applications and/or other media contained within the media drive 544 may be launched or played from the media drive 544 to provide additional functionalities to the multimedia console 500.

The multimedia console 500 may be operated as a standalone system by simply connecting the system to a television or other display. In this standalone mode, the multimedia console 500 allows one or more users to interact with the system, watch movies, or listen to music. However, with the integration of broadband connectivity made available through the network interface 524 or the wireless adapter 548, the multimedia console 500 may further be operated as a participant in a larger network community. Additionally, multimedia console 500 can communicate with processing unit 4 via wireless adaptor 548.

When the multimedia console 500 is powered ON, a set amount of hardware resources are reserved for system use by the multimedia console operating system. These resources may include a reservation of memory, CPU and GPU cycle, networking bandwidth, etc. Because these resources are reserved at system boot time, the reserved resources do not exist from the application's view. In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., pop ups) are displayed by using a GPU interrupt to schedule code to render popup into an overlay. The amount of memory used for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resync is eliminated.

After multimedia console 500 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 501 at predetermined times and intervals in order to provide a consistent system resource view to the application. The scheduling is to minimize cache disruption for the gaming application running on the console.

When a concurrent system application uses audio, audio processing is scheduled asynchronously to the gaming application due to time sensitivity. A multimedia console application manager (described below) controls the gaming application audio level (e.g., mute, attenuate) when system applications are active.

Optional input devices (e.g., controllers 542(1) and 542(2)) are shared by gaming applications and system applications. The input devices are not reserved resources, but are to be switched between system applications and the gaming application such that each will have a focus of the device. The application manager preferably controls the switching of input stream, without knowing the gaming application's knowledge and a driver maintains state information regarding focus switches. Capture device 320 may define additional input devices for the console 500 via USB controller 526 or other interface. In other embodiments, computing system 312 can be implemented using other hardware architectures. No one hardware architecture is required.

Using the present technology, an essentially “dumb” linear broadcast (dumb in that it has no associated data) may be used to enhance a user's viewing experience by automatically providing additional information that may be relevant to the linear broadcast and/or user. Aspects of the current technology include:
Identifying a scheduled TV program from Internet-based EPG data and pairing it with relevant data from another source (e.g. a private Sports Cloud service and/or partner data feeds).
Displaying an alert over HDMI pass through TV that is relevant to the TV broadcast being viewed.
Actioning on, or selecting, an alert displayed over HDMI pass through TV to invoke an interactive UI.
Identifying an internet video that is related to a linear TV broadcast.
Playing back a related internet video on TV and returning to live TV broadcast upon internet video completion

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the invention be defined by the claims appended hereto.

We claim:

1. A method for enhancing a user experience with respect to a linear broadcast presented on a display, comprising:
(a) receiving an indication from a computing device associated with the display that the linear broadcast is being displayed on the display;
(b) identifying web content relating to at least one of the linear broadcast and a user associated with the computing device; and
(c) transmitting at least one of the web content identified in said step (b), and an alert notification relating to the web content identified in said step (b), for display in an interactive display area on the display instead of or together with the linear broadcast.

2. The method of claim 1, further comprising the step of identifying the linear broadcast being displayed on the display, said step (b) at least in part identifying content relating to the identified linear broadcast.

3. The method of claim 1, wherein said step (c) comprises the step of transmitting an alert notification for display on the display over the linear broadcast, and subsequently transmitting the web content for display on the display upon receiving selection of a link in the alert notification web.

4. The method of claim 1, wherein said step (c) of transmitting content for display comprises the step of transmitting content for display in a user interface chrome framing the linear broadcast.

5. The method of claim 4, further comprising the step of streaming a web video for display on the display in response to selection of a link on the user interface chrome.

6. The method of claim 5, wherein said step of streaming a web video for display on the display comprises the step of streaming a web video for display in place of the linear broadcast.

7. The method of claim 5, wherein said step of streaming a web video for display on the display comprises the step of streaming a web video for display alongside of the linear broadcast.

8. The method of claim 1, wherein said step (c) comprises transmitting an alert notification upon identifying web content in said step (b) that is contextually relevant to the linear broadcast.

9. The method of claim 1, wherein said step (c) comprises transmitting an alert notification upon identifying web content in said step (b) that is contextually relevant to a specific portion or event in the linear broadcast.

10. A system for enhancing a user experience with respect to a linear broadcast presented on a display, comprising:
a set-top box receiving the linear broadcast from a television distribution network;
a computing device connected to the set-top box and associated with the display, the computing device receiving the linear broadcast from the set-top box and presenting it on the display, and the computing device receiving web content from a remote server related to at least one of the linear broadcast and user-defined preferences, the computing device including a processor executing an application for at least assisting in the identification of the linear broadcast, the computing device causing the display of the web content instead of or in addition to the linear broadcast in response to received input from a user.

11. The system of claim 10, further comprising a central service, network connected to the computing device, for assisting in identify the linear broadcast and for transferring the web content to the computing device.

12. The system of claim 11, further comprising a third-party content provider for providing the web content to the central service.

13. The system of claim 10, the computing device comprising a first computing device, the system further comprising a second computing device for interacting with a user interface presented on the display by the first computing device.

14. The system of claim 10, the computing device implementing a natural user interface for interacting with the application running on the processor via at least one of gestures and speech.

15. The system of claim 10, wherein the processor of the computing device causes a display of an alert notification, relating to the web content, over the linear broadcast.

16. The system of claim 15, wherein the processor of the computing device causes a display of a user interface chrome presenting the web content in response to interaction with the alert notification.

17. The system of claim 16, wherein the processor of the computing device causes a display of a companion window alongside the linear broadcast or instead of the linear broadcast in response to interaction with the user interface chrome, web content being displayed within the companion window.

18. A computer-readable media for programming a processor to perform a method of enhancing a user experience with respect to a linear broadcast presented on a display, comprising:
(a) identifying the linear broadcast being displayed on the display;
(b) receiving web content from a third-party content provider;
(c) transmitting for display an alert notification relating to the web content to a computing device associated with the display, the alert notification generated in response to a determination that the web content is related to at least one of the linear broadcast and user preferences; and
(d) transmitting the web content to the computing device for display in response to a received interaction with the displayed alert notification.

19. The computer-readable media of claim 18, further comprising display on the display of the web content instead of or alongside the linear broadcast.

20. The computer-readable media of claim 18, the computing device comprising a first computing device and the display comprising a first display, the method further comprising display of the web content on a second display of a second computing device while the linear broadcast is displayed on the first display associated with the first computing device.
